(19) United States
(12) Patent Application Publication
(10) Pub. No.: US 2018/0196397 A1
(43) Pub. Date: Jul. 12, 2018

(54) MULTIFUNCTIONAL SYSTEM FOR A WRISTWATCH

(71) Applicant: Soprod SA, Sion (CH)

(72) Inventors: Romain CLIVAZ, Grône (CH); Denis PIQUEREZ, Martigny (CH)

(21) Appl. No.: 15/744,652

(22) PCT Filed: Jun. 30, 2016
(86) PCT No.: PCT/IB2016/053932

§ 371 Date: Jan. 12, 2018

(30) Foreign Application Priority Data
Jul. 21, 2015 (CH) 01063/15

(51) Int. Cl. G04G 9/00; G04C 17/00; G04G 21/04; G04G 99/00

(52) U.S. Cl. CPC G04G 9/0082; G04C 17/0091; G04G 99/006; G04G 9/0064; G04G 21/04

(57) ABSTRACT

A multifunctional system for a wristwatch comprising: a dial surface having a plurality of spatially distinct displays; each display including an electro-optical dial portion being configured to display an information digitally, wherein the electro-optical dial portions are on a single electro-optical digital display device; each display having a mechanical analogic display device to display an information analogically and including at least one mechanical mobile; the multifunctional system further including a controller configured for controlling the analogic display devices and the electro-optical dial portions; and a selection means for selecting at least one display function from a plurality of display functions such that the controller controls at least one of the electro-optical dial portions in combination with one of the analogic display device for displaying the selected display function; wherein at least one of the electro-optical dial portions spatially overlaps at least one of the other electro-optical dial portions.

### FIELD

The present invention concerns a multifunctional system for a wristwatch. The invention further concerns a multi-functional wristwatch comprising the multifunctional system.

### DESCRIPTION OF RELATED ART

Watches allowing a variety of operation modes are known. For example, electronic watches often mix analog and numerical displays for providing a variety of functions of the type current time, alarm, wakeup alarm and stopwatch.

U.S. Pat. No. 7,505,374 discloses an electronic clock with an electronic displaying dial arranged for producing an analog clock display.

EP1046086 discloses a wristwatch having an analog display consisting in a hour and a minute hand superimposing a LCD digital displays for indicating passing seconds.

EP0939331 discloses a wristwatch having a semi-transparent crystal display arranged for displaying information on the top of the wristwatch while permitting a visual access to the underlying hand-based analog dial.

WO03056397 discloses a wristwatch with minute and hour hands operating over a dial having digital windows for displaying additional information, such as an agenda externally controlled.

EP2562609 discloses a watch comprising an analog display surrounded by a plurality of digital display units. The watch is arranged for displaying a display function that is selected by the user.

CH708234 discloses a multi-functional portable device comprising an analog display module actuated by an actuator and arranged for displaying one or more display functions simultaneously or sequentially. The portable device further comprises a control unit configured for controlling such display module according to an information received from another device.

However, the input and display capacity of most watches is limited, one side by the watch dial structure as well as the dial space available, and on the other by the user's dexterity. In order to extend this capacity, menu systems can be implemented that enable the user to sequentially select the parameters for configuring the watch in order to make it work according to a given function. Such menu systems very quickly become complex when several functionalities are to be programmed and navigating within the menus can take a lot of time and be counter-intuitive.

### SUMMARY

The present invention concerns a multifunctional system for a wristwatch comprising a dial surface comprising a plurality of spatially distinct displays; each display comprising an electro-optical dial portion being configured to display an information digitally, wherein the electro-optical dial portions are comprised on a single electro-optical digital display device; each display comprising further comprising a mechanical analogic display device to display an information analogically, the analogic display device including at least one mechanical mobile; the multifunctional system further comprising a controller configured for controlling the analogic display devices and the electro-optical dial portions; and a selection means for selecting at least one display function from a plurality of display functions such that the controller controls at least one of the electro-optical dial portions in combination with one of the analogic display device for displaying the selected display function; wherein at least one of the electro-optical dial portions spatially overlaps at least one of the other electro-optical dial portions.

In an embodiment, the selection means can be further configured for selecting a predefined typologies of digital information to be displayed on said at least one of the electro-optical dial portions.

The present invention also concerns a wristwatch comprising the multifunctional system.

The multifunctional system disclosed herein allows for displaying a large number of display functions in a readable manner on a wristwatch dial without the need to hierarchize the different display functions. In particular, the multifunctional system allows for displaying a large number of display functions without having to separate the dial in a number of region corresponding to the number of display functions being displayed.

The multifunctional system disclosed herein further allows selecting different typologies and configurations for displaying digital information on the dial. Different configurations of displays can thus be easily and freely customized on the dial.

### BRIEF DESCRIPTION OF THE DRAWINGS

The invention will be better understood with the aid of the description of an embodiment given by way of example and illustrated by the figures, in which:

FIG. 1 shows a multifunctional system comprising a plurality of spatially distinct displays, according to an embodiment;

FIG. 2 shows a cross section of the multifunctional system, according to an embodiment;

FIG. 3 illustrates a configuration of the displays, according to an embodiment;

FIG. 4 illustrates another configuration of the displays, according to an embodiment;

FIG. 5 illustrates another configuration of the displays, according to an embodiment;

FIG. 6 shows another configuration of the displays, according to an embodiment;

FIG. 7 shows another configuration of the displays, according to an embodiment;

FIG. 8 represents another configuration of the displays, according to an embodiment; and

FIG. 9 represents the multifunctional system including a remote control device, according to an embodiment.

### DETAILED DESCRIPTION OF POSSIBLE EMBODIMENTS

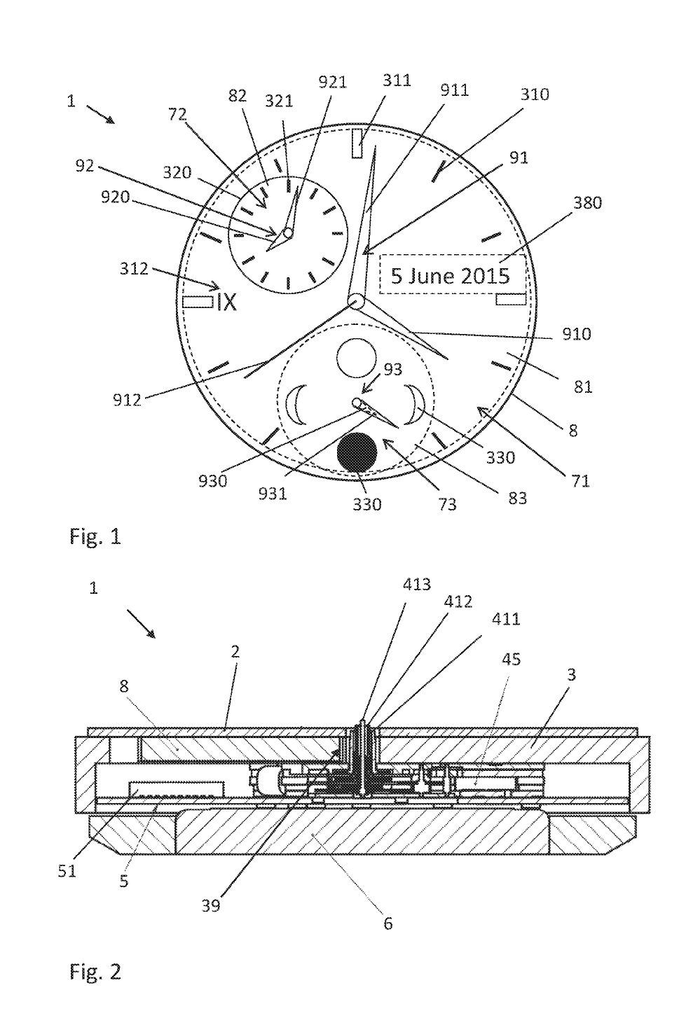

FIGS. 1 and 2 show a multifunctional system 1, according to an embodiment. The multifunctional system 1 comprises a dial 8 including a plurality of spatially distinct displays 71, 72, 73, each display comprising electro-optical dial portions 81, 82, 83 arranged for displaying information digitally, for example alpha-numeric characters, symbols or pictograms.

In the particular example of FIG. 1, the dial 8 includes a first display 71 comprising a first electro-optical dial portion 81 that occupies substantially the full dial area. The first electro-optical dial portion 81 is configured to digitally display conventional 12-hours indexes 311 at the periphery of the dial 8. The numerical information displayed by the first electro-optical dial portion 81 can also include any suitable marking such as batons 310 or numeral information 312.

The first display 71 further comprises a first mechanical analogic display device 91 for displaying an analogical information and comprising mechanical mobiles. Here, the mechanical mobiles comprise hour hand 910, the minute hand 911 and the second hand 912. Each of the hour, minute and second hands 910, 911, 912 are pivotally mounted on a corresponding concentric axes 411, 412, 413 (see FIG. 2) located in the center of the dial 8.

The dial 8 further comprises a second electro-optical display 72 (located in a quadrant between 9 h and 12 h in the example of FIG. 1) including a second dial portion 82. The second electro-optical dial portion 82 can be configured for displaying a current time related information such as a second time zone or a chronographic information. In particular, the second electro-optical dial portion 82 can be configured to digitally display any suitable 12-hours type of indexes 321. As illustrated, the second electro-optical dial portion 82 can also display a contour line 320 delimitating the second electro-optical dial portion 82.

The second display 72 further comprises a second a mechanical analogic display device 92 including, for example, an hour hand 920 and a minute hand 921 pivotally mounted on a respective axes (not visible).

The dial 8 further comprises a third display 73 including a third electro-optical dial portion 83 (located in the lower-half portion of the dial 8, at 6 h). This third electro-optical dial portion 83 can be used to digitally display an information related to the lunar cycle, such as pictograms 330 representing different phases of the moon.

The third display 73 comprises a third a mechanical analogic display device 93 comprising a pointer (hand) 930 pivotally arranged on an axe 431.

The multifunctional system 1 further comprises an actuator 45 driving the analogic display devices 91-93. A single actuator 45 can be used to actuate the analogic display devices 91-93 simultaneously or sequentially. Alternatively, each analogic display device 91-93 or each hand 910-930 can be independently actuated an individual actuator 45. The actuator 45, or actuators, can be unidirectional or bidirectional. A bidirectional actuator 45 can be useful for actuating a hand dedicated to a retrograde display function. The actuator 45 can comprise a stepping motor, a DC motor or any other actuator whose size and electric consumption make it suitable for use portable devices.

The electro-optical dial portions 81-83 are comprised on a single (integrally formed) electro-optical digital display device. In the examples of FIGS. 1 and 3-7, the single electro-optical digital display device (that coincides with the first electro-optical dial portion 81) extends substantially over the whole surface of the dial 8. The electro-optical display device can include any suitable device such as e-ink, LCD, LED or OLED.

The multifunctional system 1 can comprise a power supply unit, for example a battery module 6, as illustrated in FIG. 2. The multifunctional system 1 can also comprise a semi-transparent solar panel 2 over the dial 8 for supplying electrical power energy to the power supply unit.

In the examples of FIGS. 1 and 3-7, the electro-optical display device is provided with at least three vias 39 (see FIG. 2), each via being in spatial correspondence with the axes 411-413, 421, 422, 430 of the corresponding mechanical mobiles 910-930.

At least one electro-optical dial portion 81-83 spatially overlaps at least two analogic display device 91-93. The numerical information displayed on the electro-optical dial portion 81-83 can be arranged to cooperate with the at least two analogic display device 91-93.

Such configuration allows to optimally exploit the available dial 8 surface for simultaneously displaying a plurality of display functions on the same dial surface. In particular, as illustrated by FIG. 1, the first electro-optical dial portion 81 covers substantially the full dial 8 surface.

The dimension of each of the electro-optical dial portion 81-83 can be freely defined, for example to fit the size of the mechanical mobiles (the length of the hands 910-930) and/or to accommodate the spatial arrangement of the digital information.

The multifunctional system 1 further comprises a controller 5 configured for controlling the analogic display devices 91-93 and the electro-optical dial portions 81-83. The controller 5 can control the analogic display devices 91-93 by driving the actuator (or actuators) 45. The controller 5 can be configured to control the analogic display devices 91-93 and the electro-optical dial portions 81-83 in a continuous fashion or at specific time periods that can be periodic, random or triggered (for example by an event).

The controller 5 controls the electro-optical dial portion 81-83 and the analogic display device 91-93 such that the numerical information displayed on the electro-optical dial portion 81-83 cooperates with the at least two analogic display device 91-93.

The multifunctional system 1 can further include a computer medium comprising portions of code for a software application comprising a plurality of display functions (for example a library of functions such as those listed above), each of the display functions being configured to be executed in the multifunctional system 1.

The computer medium comprising portions of code for a software application can further comprise a plurality of predefined typologies of digital information to be displayed on the electro-optical dial portions 81-83, depending on the selected display function.

The multifunctional system 1 can further comprise a selection means for selecting at least one display function from a plurality of display functions such that the controller 5 controls at least one of the electro-optical dial portions 81-83 in combination with one of the analogic display device 91-93 for displaying the selected display function.

The selection means can be further configured for selecting a subgroup of display functions from among the plurality of display functions.

The selection means can be further configured for selecting a predefined typologies of digital information to be displayed on one of the electro-optical dial portions 81-83. The controller 5 can thus control the electro-optical dial portions 81-83 such that the selected typologies of digital information is displayed on the corresponding electro-optical dial portion 81-83 in accordance with the selected subset of display functions. For example, the selection means allows for choosing a specific set of alpha-numeric characters, symbols or pictograms to be used for a given display function on one of the electro-optical dial portions 81-83. The particular set of markings can be a set of pre-defined and/or customizable markings. The particular set of markings can include a specific spatial distribution in relation to the corresponding analogic display device 91-93.

The selecting of predefined typologies of digital information can comprise selecting a specific spatial distribution of the digital information 310-331 among the electro-optical dial portions 81-83, in relation to said one of the analogic display devices 91-93.

The selection means can comprise one or several buttons or any mechanical input mechanism provided on the multifunctional system 1. The selection means can further comprise sensor such as an accelerometer or a contact sensor.

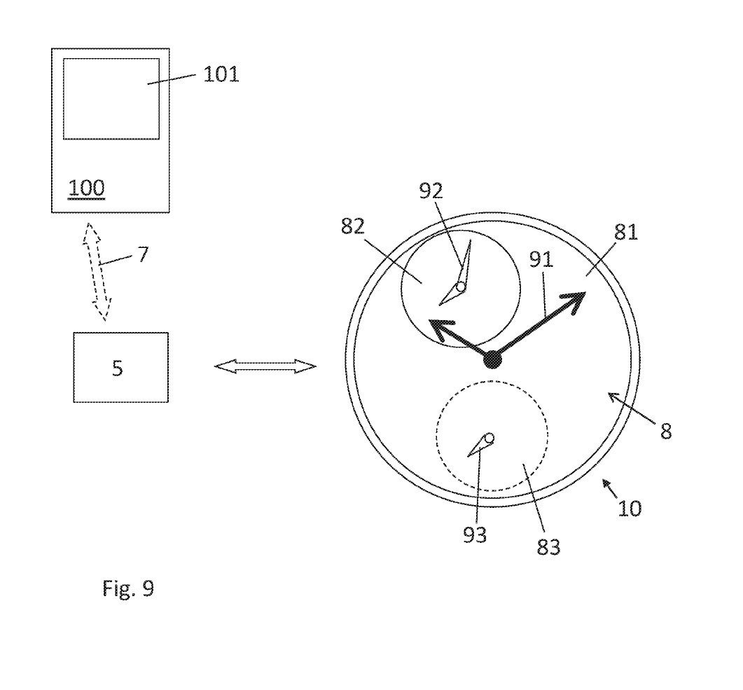

In an embodiment represented in FIG. 9, multifunctional system 1 includes a remote control device 100 that comprises the computer medium. For example, in the case where the remote control device 100 is an intelligent apparatus of the type “smartphone”, tablet or other, the computer medium can take the form of an application program installed in the intelligent device.

The selection means can be comprised in the remote control device 100. For example, the remote control device 100 can comprise input means 101 enabling a user to select the subset of functions he wishes to see be executed on the multifunctional system 1. In the example of FIG. 9, the input means 101 comprises a touch sensitive display of a smartphone. The remote control device 100 can then generate an external information 7 comprising the subgroup of display functions.

As illustrated in FIG. 9, the controller 5 can be further configured to wirelessly receive the external information 7 and control each analogic display device 91-93 and each electro-optical dial portion 81-83 in accordance with the external information 7.

In the example of FIG. 1, the selected subset of display functions comprise a current time function displayed by the first display 71, a second time zone displayed by the second display 72 and a lunar cycle displayed by the third display 73.

The subset of display functions can comprise any one of a time related function, i.e. current time, date or time indexing, dead second, time zone, stopwatch, countdown, wake-up alarm, programmable alarm clock, calendar, moon phases and sign of the zodiac. Moreover, the subset of display functions can comprise a non-horological information, such as a temperature value, a barometric value, or a watch status such as a battery load status. The subset of display functions can also include an automaton.

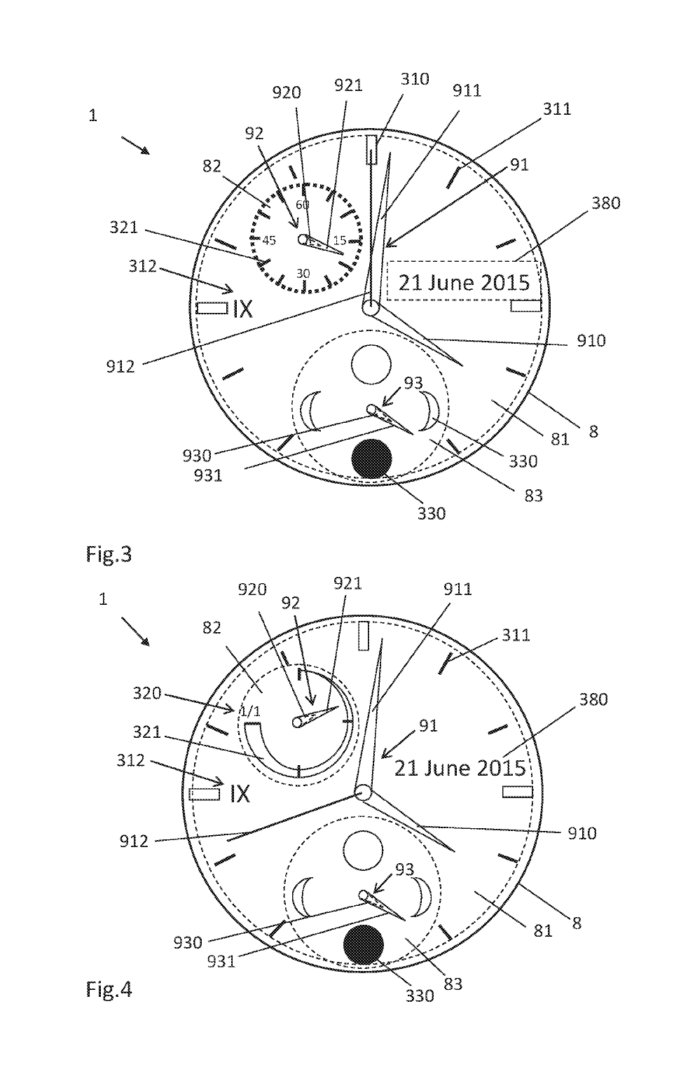

In FIG. 3, the selected subset of display functions comprise using the second display 72 to display the seconds instead of the time zone. To that end, the controller 5 acts on the second dial portion 82 such as to change the set of markers 320, 321 by a new set of markers 322, 323 adapted for displaying the seconds. Here, the new set of markers 322, 323 corresponds to a predefined typology of digital information selected to be displayed on the second electro-optical dial portions 82 in accordance with the selected function to be display on the second display 72. The controller can also act on the actuator 45 such that the two hands 920, 921 coincide and make a complete rotation per minute. In this configuration, the hour hand 920 and the minute hand 921 are used as a single pointer. Alternatively one of the hands 921, 920 can be controlled to be either immobile while the other is used as a pointer.

When changing the displayed function, the refresh rate of the dial portion 81-83 and/or the resetting of the mechanical mobiles 910-930 can be tuned, for example from a quasi-instantaneous change to a slow change. Such tuning capability can be used to produce aesthetic or artistic effects.

In FIG. 4, the selected subset of display functions comprise using the second display 72 to display a power reserve (of a watch) or a battery status. To that end, the controller 5 acts on the second dial portion 82 such as to change the set of markers 320, 321 by an arc segment 324. The controller 5 also acts on the actuator 45 such that one of the hands 920, 921 moves in accordance with the change in power reserve, along the arc segment 324.

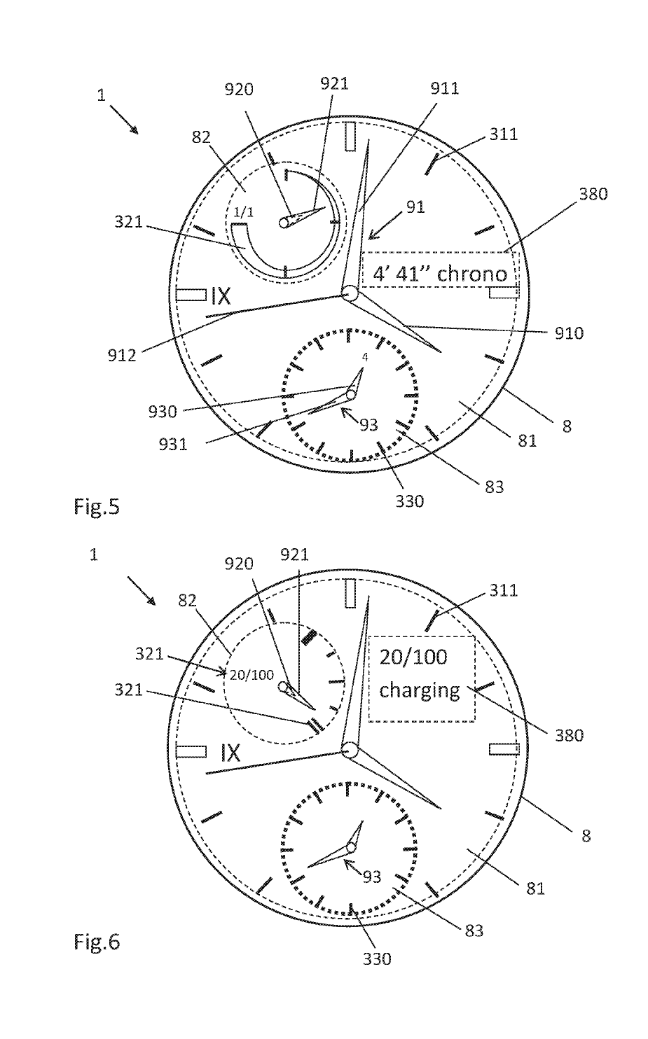

In FIG. 5, the selected subset of display functions comprise using the third display 73 as a stopwatch display. To that end, the controller 5 acts on the second electro-optical dial portion 82 such as to change the set of markers 320, 321 by 60 minute markers 332, 333. The controller 5 also acts on the actuator 45 such that one of the hands 920, 921 moves as in a stopwatch. In the configuration of FIG. 1 where the third display 73 was used to display the phases of the moon, the two hands 920, 921 are controlled such as to coincide and used as a single pointer.

The controller 5 is configured to control the electro-optical dial portions 81-83 and the analogic display devices 91-93 in operational relationship with each other. The controller 5 is configured to control the electro-optical dial portions 81-83 independently from the analogic display devices 91-93.

In FIG. 6, the second display 72 displays a power reserve (of a watch) or a battery status. Compared to the configuration of FIG. 5, the arc segment 324 is replaced by a set of markers, 321. This corresponds to a change of the predefined typology of digital information used for the second dial portion 82 for the same function.

The controller 5 can also act on the actuator 45 such that the two hands 920, 921 coincide and make a complete rotation per minute. In this configuration, the hour hand 920 and the minute hand 921 are used as a single pointer. Alternatively one of the hands 921, 920 can be controlled to be either immobile while the other is used as a pointer.

The dial 8 can comprise one or a plurality of additional electro-optical dial portions 380 configured to display an additional digital information independently to the other displayed digital information and analogical information. The additional electro-optical dial portions 380 can be controlled by the controller 5 such as to display the digital information that is not necessarily correlated with the information displayed by the displays 71-73. The additional electro-optical dial portions 380 can be controlled to display information dynamically, for example to report an event, a horological information. However, it can be further controlled to display information related (for example complementary) to the information provided by the displays 71-73.

The additional information can comprise an information not displayed by the displays 71-73, such as a calendar information (see FIGS. 1, 2 and 4) or an information complementing the one displayed on one of the displays 71-73, such as stopwatch information (see FIG. 5) or power reserve information (see FIG. 6).

The additional information can correspond to information signal generated by a sensor connected to the multifunctional system 1 or remote from it, such as a temperature sensor, pressure sensor, a vital sign sensor, etc.

The position of the additional electro-optical dial portions 380 on the dial 8 can be pre-defined or can be dynamically defined, for example, according to current available space on the dial 8 or in order to produce a visual or aesthetic effects.

In a variant, the controller is configured to dynamically vary the position of the additional electro-optical dial portion 380 depending on the movement of the mechanical mobiles 910-930, for example such that the additional electro-optical dial portion 380 is not covered by any of the mechanical mobiles 910-930.

Other arrangements of the displays 71-73 on the dial 8 are possible. The dial 8 can comprise any number of displays 71-73, this number being only limited by the constraints of the mechanical analogic display devices 91-93 (mechanical mobiles 910-930 and actuator 45) and the readability of the information provided.

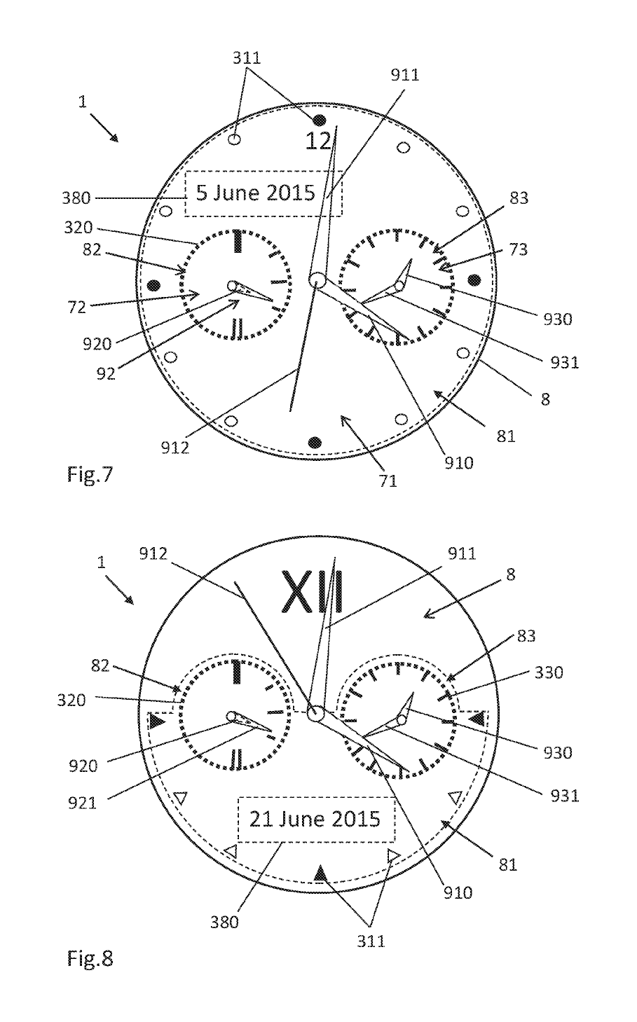

FIG. 7 shows the multifunctional system 1 according to another variant. The dial 8 is provided with a first electro-optical dial portion 81 similar to the one shown in FIGS. 1, 3-6 but where the conventional 12-hour indexes 311 have been replaced by dot-shaped markings.

The dial 8 further comprises a second display 72 located at 9 h for displaying a power reserve, and a third display located at 3 h for displaying a current time related information such as a second time zone or a chronographic information. The second display 72 includes a second electro-optical dial portion 82 displaying 12-hour indexes 320 including a contour dotted line, and a second analogic display device 92 including a pointer 920. The third display 73 includes a third electro-optical dial portion 83 displaying 12-hour indexes 320 including a contour dotted line, and a third a mechanical analogic display device 93 comprising an hour hand 930 and a minute hand 931.

FIG. 8 shows the multifunctional system 1 according to another embodiment. Here, the second display 72 and the third display 73 are similar to the ones of the example of FIG. 7. In contrast with the examples shown in the FIGS. 1, 3-7 where the electro-optical digital display device forming the electro-optical dial portions 81-83 extends substantially over the whole surface of the dial 8, here, the electro-optical digital display device covers mostly the bottom half of the dial 8. In this configuration, the first electro-optical dial portion 81 can be used to display digital makings on the lower half of the dial 8.

In other configurations not represented, the electro-optical display can be arranged to extend in the upper half of the dial 8 or in any other portion of the dial 8.

The electro-optical display device can further comprise an additional portion (not represented) that is not physically connected to it.

The the analogic display device 91-93 can comprise a single hand (or pointer), for example for indicating a unique value such as a sensor measured value, a power reserve or a lunar cycle. The the analogic display device 91-93 can comprise two or three hands for indicating a time related information.

Other arrangements of the analogic display device 91-93 are possible. For example, the analogic display device 91-93 can comprise a pivoting disk or a plurality of pivoting disks. The mechanical mobile or mobiles can pivot around an axe that is substantially parallel to the dial 8 surface, for example a drum. The analogic display device 91-93 can comprise an automaton.

The multifunctional system 1 is suitable to be comprised in a portable device including a timepiece such as a wristwatch, a pocket watch or any other portable device capable of displaying information, such as a pedometer, an activity tracker etc.

### LIST OF REFERENCE NUMERALS

1 multifunctional system
2 solar panel
100 remote control device
310-312 marking, index, pictogram
320, 321 marking, index
330, 331 pictogram
380 additional electro-optical dial portion
39 via
411-413 axe
45 actuator
5 controller
51 wireless transmission circuit
6 battery module
71 first display
72 second display
73 third display
8 dial
81 first electro-optical dial portion
82 second electro-optical dial portion
83 third electro-optical dial portion
91 first analogic display device
92 second analogic display device
93 third analogic display device
910-930 mechanical mobiles, hand, pointer

1. A multifunctional system for a wristwatch comprising:
a dial surface comprising a plurality of displays;
each display comprising an electro-optical dial portion being configured to display an information digitally, wherein the electro-optical dial portions are comprised on a single electro-optical digital display device, and wherein at least one of the electro-optical dial portions spatially overlaps at least one of the other electro-optical dial portions;
each display further comprising a mechanical analogic display device to display an information analogically, the analogic display device including at least one mechanical mobile, the mechanical analogic display devices being spatially distinct;
the multifunctional system comprising a controller configured for controlling the analogic display devices and the electro-optical dial portions; and
the multifunctional system further comprising a selection means for selecting at least one display function from a plurality of display functions comprising any one of a time-related function and a non-horological function such that the controller controls at least one of the electro-optical dial portions in combination with one of the analogic display device for displaying the selected display function;
such that said at least one of the electro-optical dial portions in combination with one of the analogic display device is changeable from displaying a time related function or a non-horological function to, respectively, a non-horological function or a time related function, in accordance with the selected display function.

2. The multifunctional system according to claim 1, wherein the selection means can be further configured for selecting a predefined typologies of digital information to be displayed on said at least one of the electro-optical dial portions.

3. The multifunctional system according to claim 2, wherein said predefined typologies of digital information comprise a set of alpha-numeric characters, symbols or pictograms.

4. The multifunctional system according to claim 2, wherein said predefined typologies of digital information comprise a specific spatial distribution of the digital information among the electro-optical dial portions, in relation to said one of the analogic display devices.

5. The multifunctional system according to claim 1, further comprising a remote control device communicating with the multifunctional system; and
wherein the selection means is comprised in the remote control device.

6. The multifunctional system according to claim 1, wherein at least one of the mechanical analogic display device comprises at least one hand pivotally mounted on a distinct axis.

7. The multifunctional system according to claim 6, wherein said distinct axis passes in a via provided in the corresponding electro-optical dial portion.

8. The multifunctional system according to claim 1, wherein the electro-optical digital display device comprising the electro-optical dial portions extends substantially over the whole surface of the dial.

9. The multifunctional system according to claim 8, wherein one of the electro-optical dial portions extends substantially over the whole surface of the dial.

10. The multifunctional system according to claim 1, wherein the electro-optical digital display device comprising the electro-optical dial portions extends on a portion of the dial surface.

11. The multifunctional system according to claim 10, wherein one of the electro-optical dial portions extends in the lower half of the dial.

12. The multifunctional system according to claim 1, wherein the dial comprises an additional electro-optical dial portion configured to display an additional digital information independently to the information digitally and analogically displayed by the electro-optical dial portions and the mechanical analogic display device.

13. A wristwatch comprising the multifunctional system according to claim 1.
